(19) United States
(12) Patent Application Publication
(10) Pub. No.: US 2016/0253747 A1
(43) Pub. Date: Sep. 1, 2016

(54) AUTOMATED SERVICE SYSTEM WITH USER'S AUTOMATIC IDENTIFICATION

(71) Applicant: LOCALIZA RENT A CAR S.A, Belo Orizonte, Minas Gerais (BR)

(72) Inventors: Alberto Wagner TEIXEIRA CAMPOS, Belo Horizonte (BR); Gustavo GONTIJO LEAL, Belo Horizonte (BR)

(21) Appl. No.: 14/423,971

(22) PCT Filed: Aug. 21, 2014
(86) PCT No.: PCT/BR2014/000287

§ 371 Date: Feb. 25, 2015

(30) Foreign Application Priority Data
Jun. 6, 2014 (BR) 1020140138005

(51) Int. Cl. G06Q 30/06; G06Q 20/18; G06K 9/00; G06Q 20/20

(52) U.S. Cl. CPC G06Q 30/0645; G06Q 20/206; G06Q 20/18; G06K 9/00288; G06K 9/00442

(57) ABSTRACT

An automated service system with automatic user identification involving a self-service terminal equipped with a facial biometric recognition system with frontal camera, the camera being composed by an outer body for the frontal camera, flat surface coupled to such body, an_image capturing device (digital camera or digitalizing scanner), LED light (Light Emitting Diode) for internal illumination of the camera, and polarizing filters to adjust the camera internal illumination. An automated service process with automatic user identification is also disclosed.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention makes reference to an automated self-service system with user's automatic identification, more particularly applied to an self-service terminal developed for car rental services.

2. Description of Related Art Including Information Disclosed Under 37 CFR 1.97 and 37 CFR 1.98.

The automated self-service terminals were first introduced during the 60's from independent and simultaneous initiatives in Japan, Sweden, United Kingdom and United States of America. The automated self-service terminals are commonly characterized for allowing the user to perform an operation/transaction in an unassisted manner.

In order to guarantee safety and reading capacity, these machines read coupons printed with isotopes (lightly radioactive) of Carbon 14. Subsequently, the concept of a personal password (or PIN—Personal Identification Number) was adopted in conjunction with cards equipped with magnetic stripes or microchips. Such cards are used to verify the identity of the users of automated self-service systems without the need for human intervention.

The automated self-service machines belonging to the prior state of the art for services whose user's identification is mandatory, depend upon a personal password and a physical device such as the magnetic card. With the exception of services where checking documentation is performed a posteriori (for example: self-service in airline companies). In these cases, the user provides a confirmation code or his identification number to confirm the utilization of such service (for example: check-in for a flight), and subsequently, has his respective documentation verified by an agent before using the service at hand.

The persisting problem is that for the identification/validation of the user, current terminals require the utilization of a physical device specifically produced for such operations (magnetic card, for example), followed by the use of a password or in the absence of such and, in some cases, the employment of digital biometry, which increases the cost of the self-service process.

Another problem is that in the car rental commercial activity, such self-service terminals have no known application, where the car rental process is performed in an assisted manner at the service counter of car rental facilities.

### BRIEF SUMMARY OF THE INVENTION

The present invention has the objective of allowing self-service without the use of physical devices specifically designed for its operation.

Another objective is to provide self-service with substantial level of safety for the user and the service provider.

It constitutes another objective to provide self-service in the car rental operation.

These objectives are reached by means of a system which involves a self-service terminal equipped with facial biometric recognition.

The automated identification of clients is based on the biometric comparison of the existing faces in multiple images. One of such images is the previously digitalized image from the user's identification card. The other is an image taken from the document presented by the client at the moment of the automated service.

Another technology relevant to the solution is text recognition, better known as OCR (Optical Character Recognition), which allows for the transformation of text data contained in the client's document in digital data which can be treated by a computer system. Such treatments include the registration or validation of the information contained in the document presented by the client.

The user positions his document at a location indicated of a flat surface of the front camera for image capturing. Next, the biometric recognition mechanism is triggered to identify the face existing in the photo of the document presented by the client and compare it to the faces registered in the company's data base of documents previously stored. When a similarity level between the document's face presented and a previously registered face reaches a pre-established threshold, and initial validations take place, the client's self-service process is continued. If such pre-established threshold is not reached, the user is presented with the option of repeating the biometric recognition process or type in the number of his personal identification document or type the number if his record locator or confirmation card of his car rental reservation.

After the identification of the user, he performs the following tasks in the automated service system:
1) Confirmation of the client's reservation data including the possibility to change the vehicle model to be rented;
2) Addition of optional services in accordance to his own personal preferences;
3) Acceptance of the Contractual terms and conditions.

That which is offered by the present invention is the combination of known elements in such a manner as to generate a system equipped with an innovative technical effect in its field of application.

Thus, an advantage of the invention is to reduce implementation costs for the operation of automated service terminals, doing away with the need to produce and use media, magnetic cards and registration of PINS.

Another advantage is to make the user's identification/validation safer, reducing the risk of fraud.

Another benefit of the present invention is determined by the fact that the present system may be applied over other systems in addition to car rental services.

### BRIEF DESCRIPTION OF THE DRAWINGS

FIG. 1—view in perspective of the self-service terminal with the user's automated identification;

FIG. 2—diagram of blocks illustrating the automated identification of the user;

FIG. 3—diagram of blocks illustrating the self-service system with automated user's identification;

FIG. 4—illustration of the initial screen;

FIG. 5—illustration of the identification screen through the use of biometric recognition;

FIG. 6—illustration of the alternative identification screen via document number or reservation record locator;

FIG. 7—illustration of the confirmation screen for reservation data;

FIG. 8—illustration of the screen for change of the rented vehicle model;

FIG. 9—illustration of the screen for change of optional services;

FIG. 10—illustration of the screen for acceptance of the contractual terms;

FIG. 11—illustration of the instructions screen for signature of the contract and collection of the respective keys;

FIG. 12—illustration of the final Thank You notice screen.

### DETAILED DESCRIPTION OF THE INVENTION

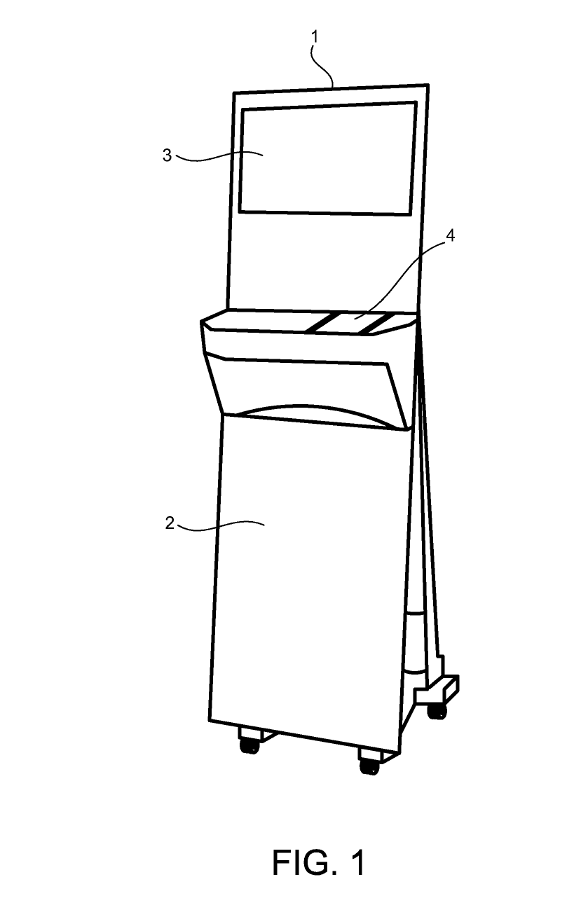

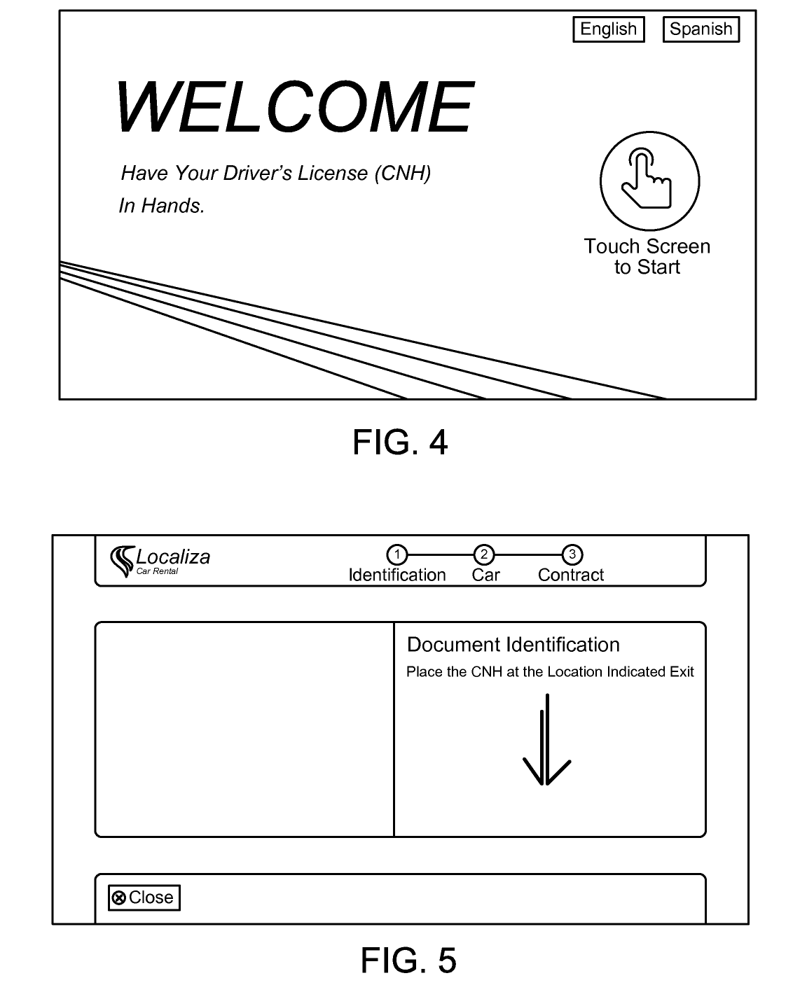

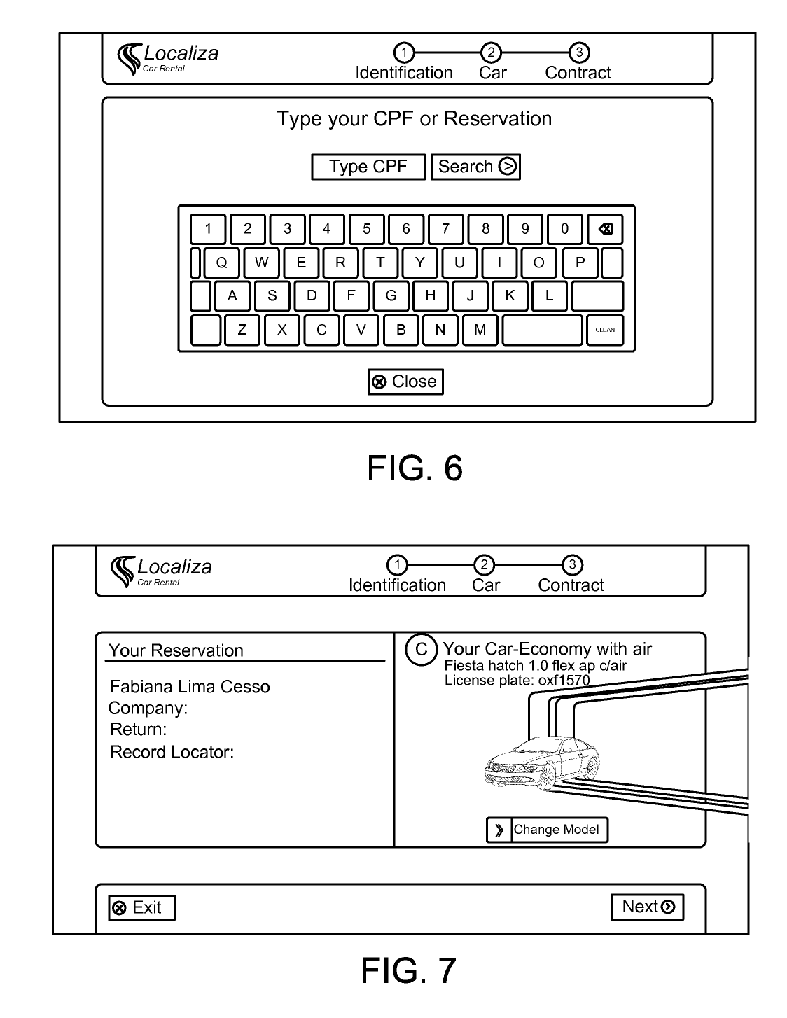

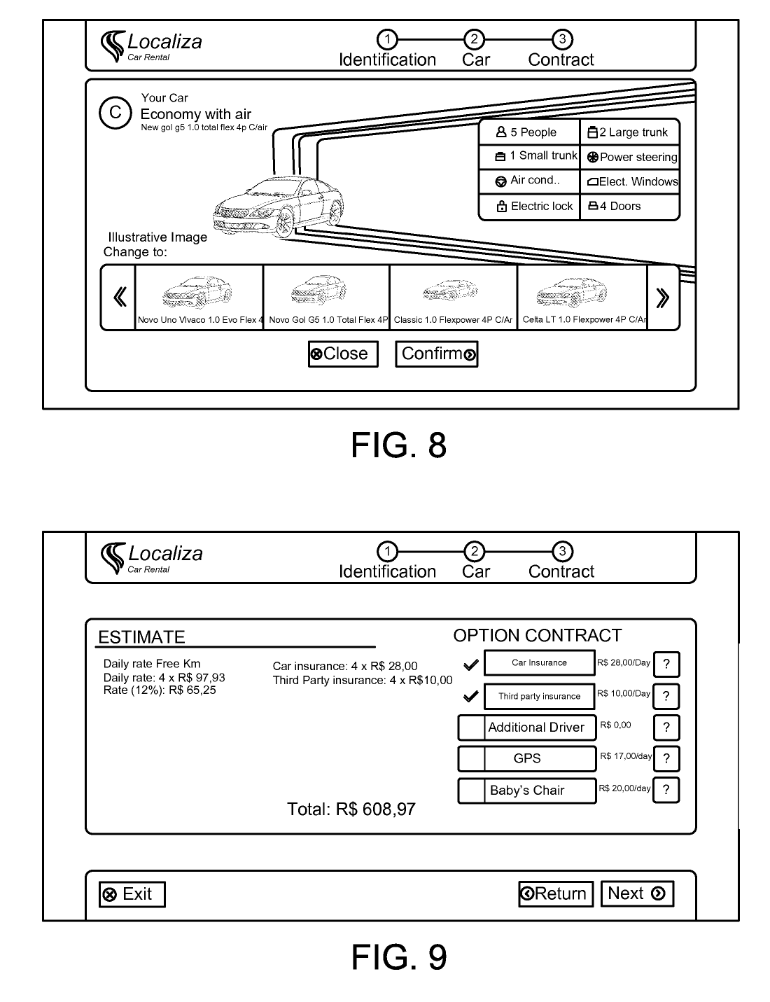

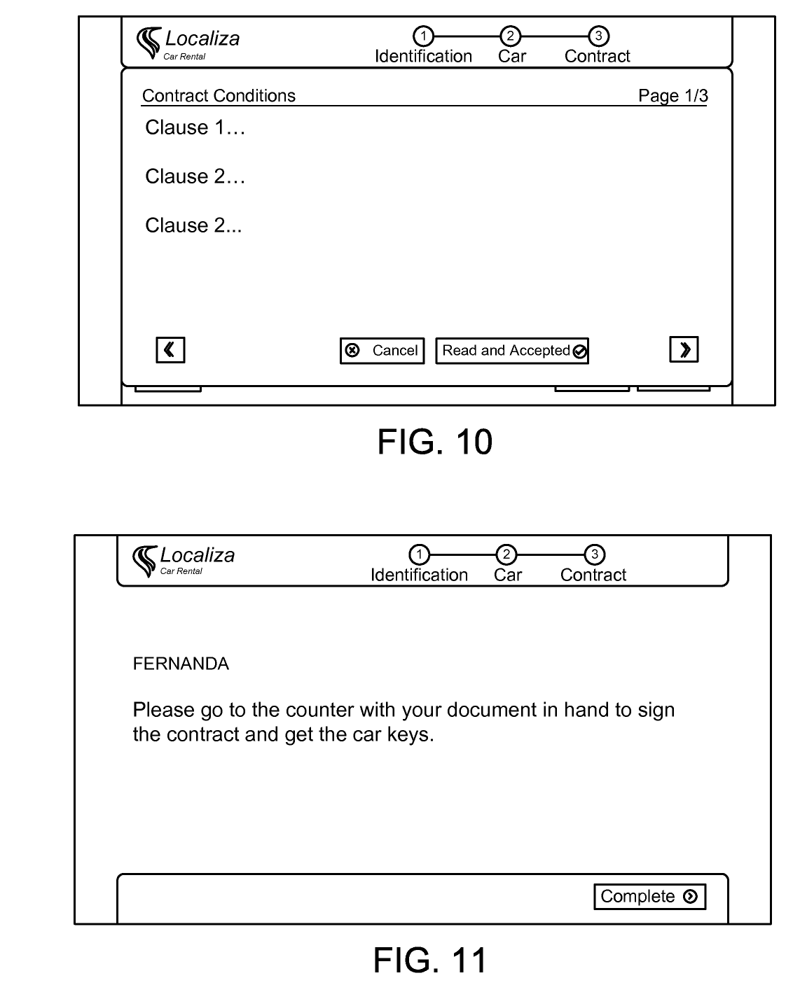

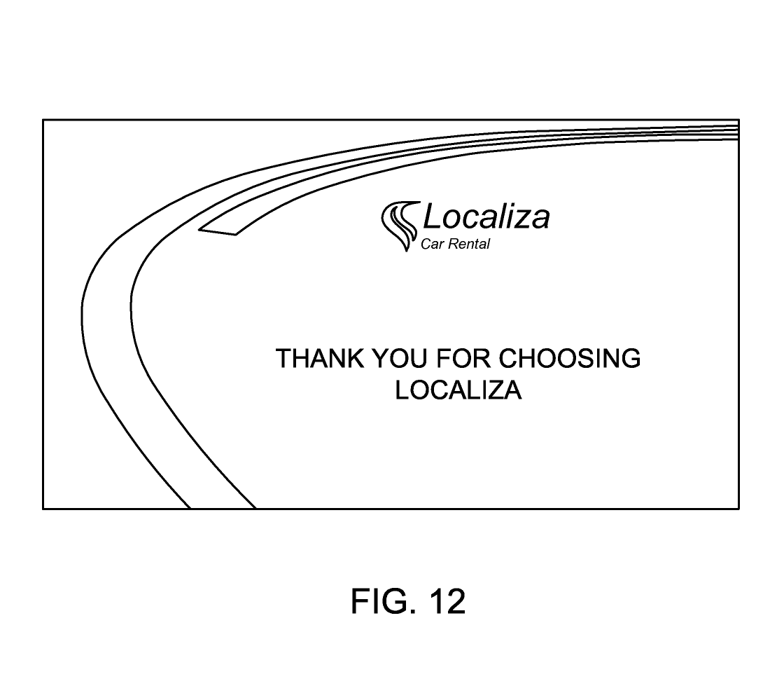

Through FIGS. 1-12 the system is demonstrated in accordance with the present invention which includes an self-service terminal (1), a totem (2), a microcomputer, a touch screen (3), a frontal camera (4) to capture the images.

The aforementioned camera is composed by an outer body for the frontal camera, flat surface coupled to such body; an image capturing device (digital camera or digitalizing scanner), LED light (Light Emitting Diode) for internal illumination of the camera, polarizing filters to adjust the camera internal illumination.

It is understood, however, that other assembly methods may be used, such as, for example, the assembly of such terminal on a counter, in a corner, or opening of a wall. Such modifications are maintained within the scope of the inventive activity.

Due to the objectivity of the description, other possible combinations of such elements based on the aspects of the aforementioned invention are not presented. However, those with profound knowledge on the subject shall recognize unequivocally as optional qualities for the system such interchangeable characteristics for each respective aspect.

In accordance with the invention, the system is equipped with an operating computer software application to implement the respective stages of the automated service process.

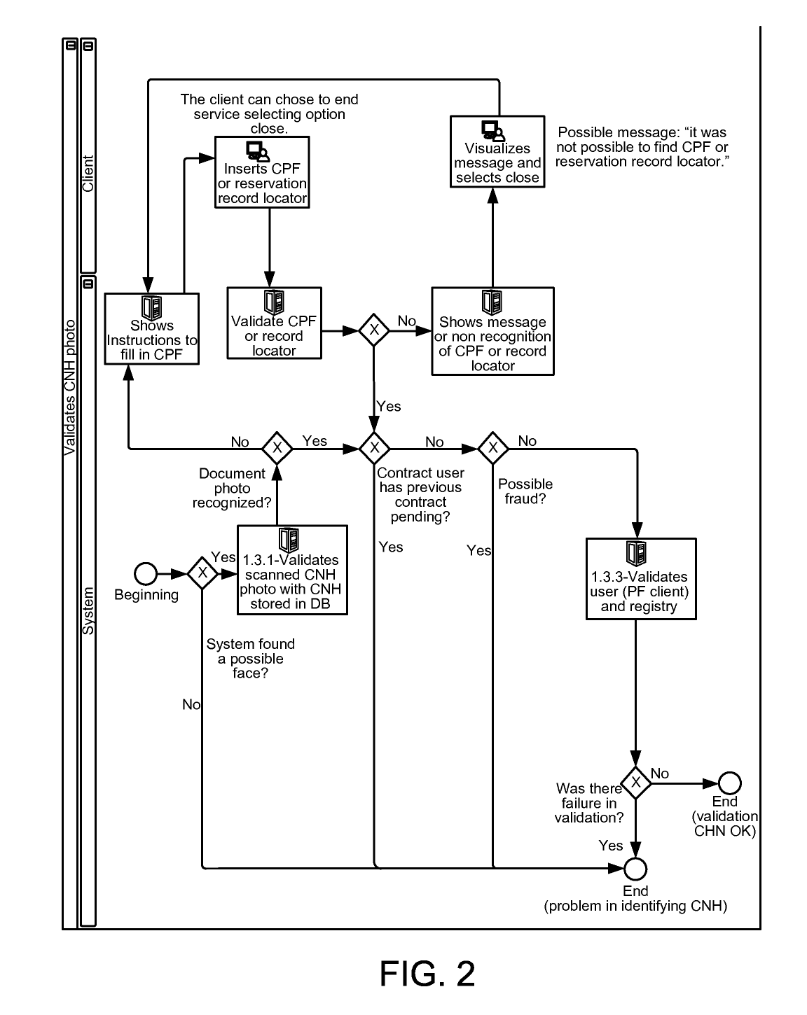

The system in accordance with the invention involves the following stages as indicated on the blocks contained under the Diagram of FIG. 2:
Validates picture from the Driver's License (CNH); system found a possible face?
If NO, process ends; problem in identifying Driver's License (CNH);
If YES, validates image from Driver's License (CNH) digitalized with image from Driver's License (CNH) stored in the database;
Validates image from digitalized Driver's License (CNH) with image from Driver's License (CNH) stored in the database; image from document recognized?
If NO, it presents instructions to fill in Natural Person Registration Number (CPF); inserts CPF or reservation record locator number; validates CPF or record locator number; validates CPF or record locator number; valid CPF or record locator?
If NO, it shows a message notifying the non-recognition of the CPF or record locator number, views message and selects close; possible message: it was not possible to find CPF or Reservation Record Locator Number ; shows instructions to fill in CPF;
If YES, contract's user has an open previous contract?
If YES, process ends; problem in identifying the Driver's License (CNH);
If NO, possible swindler?
If YES, process ends; problem in identifying the Driver's License (CNH);
If NO, validates user (Natural Person Client) and registration; was there a validation failure?
If YES, process ends; problem in identifying the Driver's License (CNH);
If NO, process ends; Driver's License validation OK;
If YES, contract's user has previous open contract?
If YES, process ends; problem in identifying the Driver's License (CNH);
If NO, possible swindler?
If YES, process ends; problem in identifying the Driver's License (CNH);
If NO, validates user (Natural Person Client) and registration; was there a validation failure?
If YES, process ends; problem in identifying the Driver's License (CNH);
If NO, process ends; Driver's License validation OK;

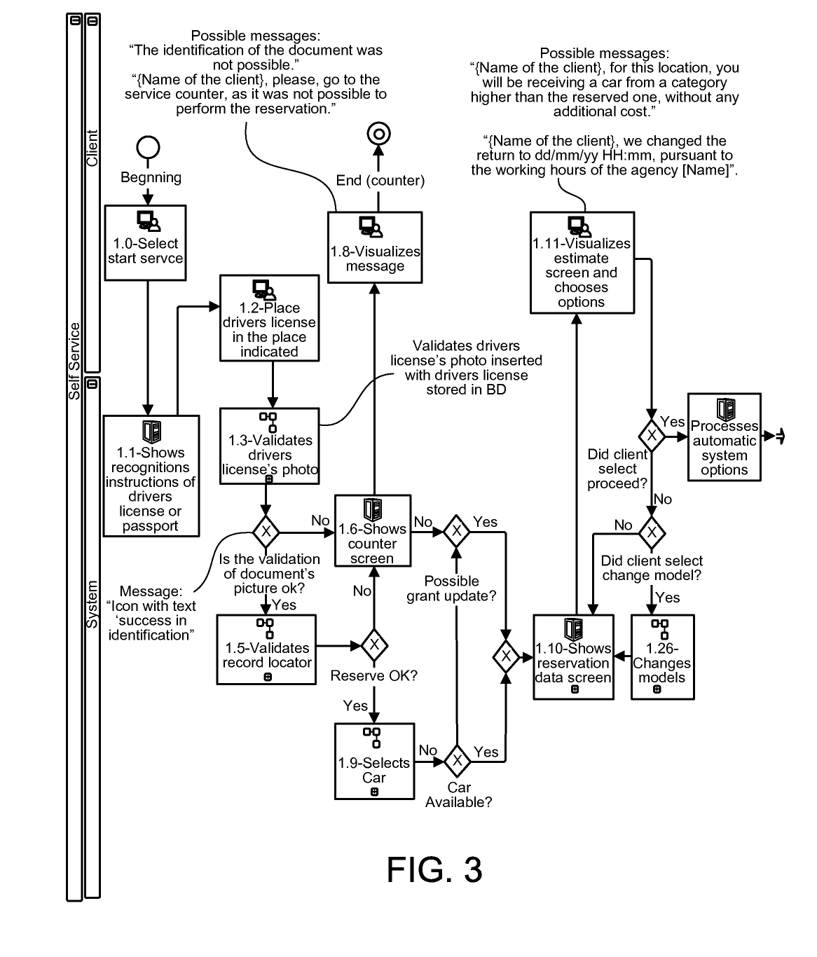

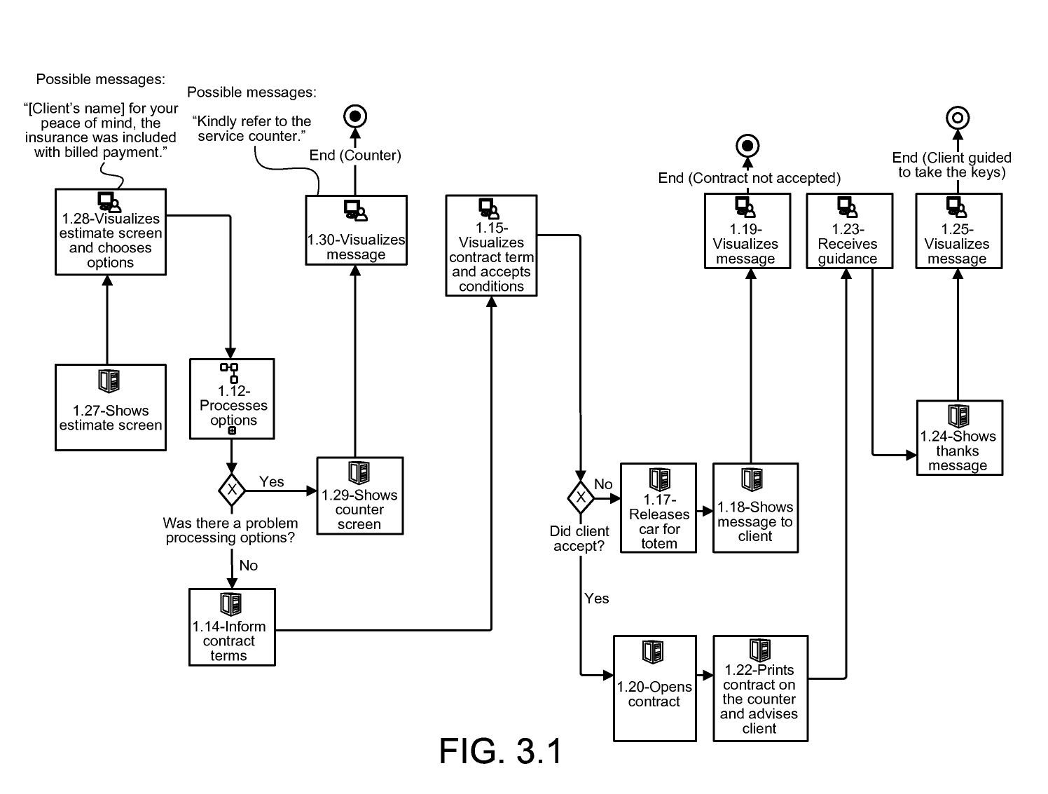

The system, in accordance with the invention also includes the following stages indicated in the blocks on the diagram contained in FIG. 3:
Selects start self-service;
Presents instructions of Driver's License (CNH) recognition;
Positions Driver's License (CNH) on the indicated location;
Validates image from digitalized Driver's License (CNH) with image from Driver's License (CNH) stored in the database; Document image validation OK?
If YES, it validates reservation record locator number;
If NO, it presents counter screen;
It validates reservation record locator number; Reservation OK?
If YES, selects vehicle;
If NO, shows counter screen;
Presents service counter screen: views message;
View message: Identification of the document was not possible or Client Name, please, go to the service counter because it was not possible to process the reservation; end service counter;
Selects vehicle; Vehicle available?
If YES, presents screen with reservation data;
If NO, is it possible to grant an upgrade?
If NO, presents service counter screen; visualizes message: Identification of the document was not possible or Client Name, please, go to the service counter because it was not possible to process your reservation; end service counter;
If yes, shows reservation data screen;
Shows reservation data screen; visualizes reservation data screen; chooses options; possible messages: Client Name, for this rental service you are receiving a vehicle of a superior category to that reserved without additional costs; Client Name, we readjusted the vehicles return to dd/mm/yyyy HH:mm, according to the business hours of Agency (Name);
Views reservation data screen and chooses options; client selects proceed?
If NO, client selects change model?
If YES, changes model; If NO, shows reservation data screen;
If YES, processes automatic options in the system; shows estimate screen; visualizes estimate screen and chooses options: Client Name, for your peace of mind, the insurance was included in the invoiced payment; processes options;
Processes options; was there a problem in processing options?
If YES, shows service counter screen, visualizes message:
Please, go to the service counter; end service counter;
If NO, informs the contractual terms, visualizes contractual term and accept the conditions; client accepted?
If NO, releases vehicle to totem; shows message to client; visualizes message; end of contract not accepted;
If YES, opens contract; prints contract on the counter and instructs client; receives instructions; shows Thank You Message; visualizes message: end client instructed to retrieve keys.

The stages herein described may be performed in any order provided they are suitable to the automated service. The self-service process implemented herein by the computer software application may be performed in readable manner by machine in a tangible storage media or as a propagation signal.

Terms such as “understood”, “included” herein used shall indicate an exemplary list of elements or stages, never an exhaustive list.

1. Automated Service with User's Automatic Identification including a totem, a microcomputer, a touch screen, characterized by a self-service terminal equipped with facial biometric recognition system with frontal camera, whose camera is composed by a body to protect the frontal camera, flat surface coupled to the body; image capturing device, LED light for internal illumination of the camera, polarizing filters for adjustment in the camera's internal illumination.

2. Automated Service with User's Automatic Identification in accordance with claim 1 characterized by a process which includes the following stages during the facial biometric recognition process:
Validates picture from Driver's License (CNH); system found a possible face?
If NO, process ends; problem in identifying Driver's License (CNH);
If YES, validates image from Driver's License (CNH) digitalized with image from Driver's License (CNH) stored in the database;
Validates image from digitalized Driver's License (CNH) with image from Driver's License (CNH) stored in the database; image from document recognized?
If NO, presents instructions to fill in Natural Person Registration Number (CPF); inserts CPF or reservation record locator number; validates CPF or record locator number; valid CPF or record locator number?
If NO, shows a message notifying the non-recognition of the CPF or record locator number, visualizes message and selects close; possible message: it was not possible to find CPF or Reservation record locator Number; shows instructions to fill in CPF;
If YES, contract's user has previous open contract?
If YES, process ends; problem in identifying the Driver's License (CNH);
If NO, possible swindler?
If YES, process ends; problem in identifying the Driver's License (CNH);
If NO, validates user (Natural Person Client) and registration; was there a validation failure?
If YES, process ends; problem in identifying the Driver's License (CNH);
If NO, process ends; Driver's License validation OK;
If YES, contract's user has previous open contract?
If YES, process ends; problem in identifying the Driver's License (CNH);
If NO, possible swindler?
If YES, process ends; problem in identifying the Driver's License (CNH);
If NO, validates user (Natural Person Client) and registration; was there a validation failure?
If YES, process ends; problem in identifying the Driver's License (CNH);
If NO, process ends; Driver's License validation OK;

3. The automated service system with automatic user's identification in accordance with claim 2 characterized by a process which involves the following stages:
Selects start automated service;
Presents instruction to recognize Driver's License (CNH);
Positions Driver's License (CNH) on the indicated location;
Validates image from digitalized Driver's License (CNH) with image from Driver's License (CNH) stored in the database; Document image validation OK?
If YES, validates reservation record locator number;
If NO, presents service counter screen;
Validates reservation record locator number; Reservation OK?
If YES, selects vehicle;
If NO, presents service counter screen;
Shows service counter screen: visualizes message;
Visualizes message: Identification of the identification was not possible or Client Name, please, go to the service counter since it was not possible to process your reservation; end service counter;
Selects vehicle; Vehicle available?
If YES, shows screen with reservation data;
If NO, is it possible to grant an upgrade?
If NO, shows service counter screen; visualizes message:
Identification of the document was not possible or Client Name, please, go to the service counter since it was not possible to process your reservation; end service counter;
If YES, shows reservation data screen;
Shows reservation data screen; visualizes reservation data screen; chooses options; possible messages: Client Name, for this rental service you are receiving a vehicle from a superior category to that reserved without additional costs; Client Name, we readjusted the vehicle's return to dd/mm/yyyy HH:mm, according to the business hours from Agency (Name);
Visualizes reservation data screen and chooses options; client selects proceed?
If NO, client selects change model?
If YES, client changes model; If NO, shows reservation data screen;
If YES, processes automatic options in the system; shows estimate screen; visualizes estimate screen and chooses options: Client Name, for your peace of mind the insurance policy was included in the invoiced payment; processes options;
Processes options; was there a problem in processing options?
If YES, shows service counter screen, visualizes message: Please, go to the service counter; end service counter;
If NO, informs the contractual terms, shows contractual terms conditions and accepts the conditions; client accepted?
If NO, releases vehicle to totem; shows message to client; visualizes message; ends contract not accepted;
If YES, opens contract; prints contract on the counter and instructs client; receives instructions; shows Thank You Message; visualizes message: ends client instructed to retrieve keys.
